(19) United States
(12) Patent Application Publication
(10) Pub. No.: US 2019/0019525 A1
(43) Pub. Date: Jan. 17, 2019

(54) AUDIO PROCESSING METHOD AND AUDIO PROCESSING DEVICE

(71) Applicant: Yamaha Corporation, Hamamatsu (JP)

(72) Inventor: Akira MAEZAWA, Hamamatsu (JP)

(21) Appl. No.: 16/135,818

(22) Filed: Sep. 19, 2018

Related U.S. Application Data
(63) Continuation of application No. PCT/JP2017/011375, filed on Mar. 22, 2017.

(30) Foreign Application Priority Data
Mar. 24, 2016 (JP) 2016-060425

(51) Int. Cl. G10L 21/01; G10L 25/06; G10L 21/04

(52) U.S. Cl. CPC G10L 21/01; G10L 21/04; G10L 25/06

(57) ABSTRACT

An audio processing device includes a feature extraction unit and signal generating unit. The feature extraction unit is configured to extract a feature quantity of a first audio signal for each of a plurality of periods. The signal generating unit is configured to for generate a second audio signal by time axis expanding/compressing either a section of the first audio signal in which the feature quantity is steadily maintained for a period time, or a section of the first audio signal in which a fluctuation of the feature quantity is repeated and excluding from the time axis expanding/compressing a section of the first audio signal in which a fluctuation of the feature quantity is not similar to that of other sections of the first audio signal.

### CROSS-REFERENCE TO RELATED APPLICATIONS

This application is a continuation application of International Application No. PCT/JP2017/011375, filed Mar. 22, 2017, which claims priority to Japanese Patent Application No. 2016-060425 filed in Japan on Mar. 24, 2016. The entire disclosures of International Application No. PCT/JP2017/011375 and Japanese Patent Application No. 2016-060425 are hereby incorporated herein by reference.

### BACKGROUND

### Technological Field

The present invention relates to technology for processing audio signals.

### Background Technology

Time stretching technology for expanding/compressing (expanding or compressing) audio signals while maintaining the pitch and sound quality (for example, phonemes) has been proposed in the prior art. For example, Japanese Laid-Open Patent Application No. 2006-17900 (Patent Document 1) discloses technology to expand/compress audio signals on a time axis by means of decimation or interpolation, using a processing frame length that corresponds to the pitch of the audio signal as the unit.

### SUMMARY

However, for example, if transient sections such as a glissando, in which the acoustic characteristics fluctuate unsteadily, are expanded and compressed on the time axis in the same manner as for steady sections in which the acoustic characteristics are steadily maintained, the listener could perceive sound that creates an unnatural impression and that deviates from the sound before its expansion or compression. An audio processing;method in accordance with some embodiments including; extracting feature quantities from a first audio signal for each of a plurality of periods, and generating a second audio signal by time axis expanding/compressing on a time axis either a section of the first audio signal in which the feature quantity is steadily maintained for a period time, or a section of the first audio signal in which a fluctuation of the feature quantity is repeated and excluding from the time axis expanding/compressing a section in which a fluctuation of the feature quantity is not similar to that of other sections.

An audio processing method in accordance with some embodiments including: extracting a feature quantity of a first audio signal for each of a plurality of first periods, calculating a similarity index of the feature quantity between each of the plurality of first periods, executing a time correspondence process for making the plurality of first periods correspond to a plurality of second periods within a target period after expansion/compression of the first audio signal, in accordance with the similarity index and a transition cost for transitioning between each of the plurality of first periods, and generating a second audio signal over the target period from a result of making the plurality of first periods correspond to each of the plurality of second periods.

An audio processing device in accordance with some embodiments including: an electronic controller having a feature extraction unit and a signal generating unit. The feature extraction unit is configured to extract a feature quantity of a first audio signal for each of a plurality of periods. The signal generating unit is configured to generate a second audio signal by time axis expanding/compressing on a time axis either a section of the first audio signal in which the feature quantity is steadily maintained for a period time, or a section of the first audio signal in which a fluctuation of the feature quantity is repeated and excluding from the time axis expanding/compressing a section in which a fluctuation of the feature quantity is not similar to that of other sections of the first audio signal.

An audio processing device in accordance with some embodiments including: an electronic controller having a feature extraction unit, an index calculation unit, an analysis processing unit and a signal generating unit. The feature extraction unit is configured to extract a feature quantity of a first audio signal for each of a plurality of first periods. The index calculation unit is configured to calculate a similarity index of the feature quantity between each of the plurality of first periods. The analysis processing unit is configured to make the plurality of first periods correspond to a plurality of second periods within a target period after expansion/compression of the first audio signal in accordance with the similarity index and a transition cost for transitioning between each of the plurality of first periods. The signal generating unit is configured to generate a second audio signal over the target period from a result obtained upon the analysis processing unit making the plurality of first periods correspond to the plurality of second periods.

### BRIEF DESCRIPTION OF THE DRAWINGS

FIG. 1 is a block diagram of an audio processing device according to a first embodiment.

FIG. 2 is an explanatory view of the time axis expansion/compression of an audio signal.

FIG. 3 is an explanatory view of a similarity matrix.

FIG. 4 is a flowchart of a time correspondence process executed by the electronic controller.

FIG. 5 is an explanatory view of a basic cost matrix having basic costs as elements.

FIG. 6 is an explanatory view of a transition matrix.

FIG. 7 is a flowchart of a time axis expansion/compression process executed by the electronic controller.

FIG. 8 is an explanatory view of a relationship between audio signals for the period before and after time axis expansion/compression.

FIG. 9 is an explanatory view of a relationship between audio signals for a basic cost in a second embodiment.

FIG. 10 is an explanatory view of a relationship between audio signals for a basic cost in a third embodiment.

### DETAILED DESCRIPTION OF THE EMBODIMENTS

### First Embodiment

Selected embodiments will now be explained with reference to the drawings. It will be apparent to those skilled;in the position detection field and the substrate field from this disclosure that the following descriptions of the embodiments are provided for illustration only and not for the purpose of limiting the invention as defined by the appended claims and their equivalents.

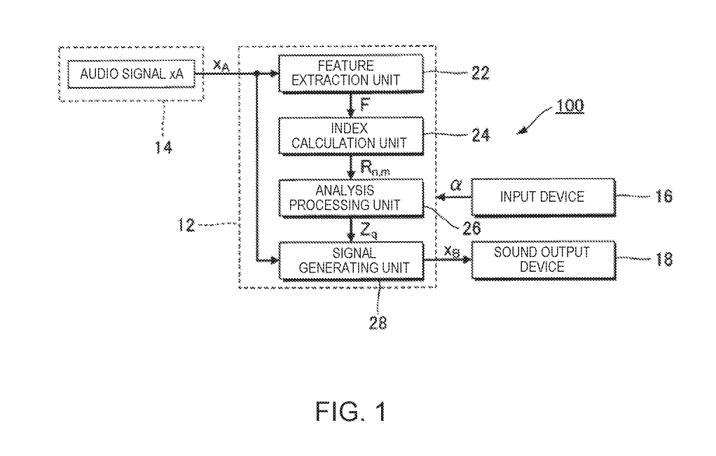

FIG. 1 is a block diagram of an audio processing device 100 according to the first embodiment. As illustrated in FIG. 1, the audio processing device 100 according to the first embodiment is realized by a computer system comprising an electronic controller 12, a computer storage device 14, an input device 16, and a sound output device 18. For example, a portable information processing device such as a mobile phone or a smartphone, or a portable or stationary information processing device such a personal computer, can be used as the audio processing device 100.

A program that is executed by the electronic controller 12 and various data that are used by the electronic controller 12 are stored in the storage device 14. The storage device 14 is any computer storage device or any computer readable medium with the sole exception of a transitory, propagating signal. The storage device 14 can include nonvolatile memory and volatile memory. For example, the storage device 14 can includes a ROM (Read Only Memory) device, a RAM (Random Access Memory) device, a hard disk, a flash drive, etc. Thus, any known storage medium, such as a magnetic storage medium or a semiconductor storage medium, or a combination of a plurality of types of storage media can be freely employed as the storage device 14. An audio signal x_{A} (example of a first audio signal) that represents various sounds such as musical sounds, voice, and the like are stored in the storage device 14 of the first embodiment. It is also possible, for example, to supply an audio signal x_{A} to the audio processing device 100 from a reproduction device that reproduces the audio signal x_{A} that is stored in a storage medium, such as an optical disc.

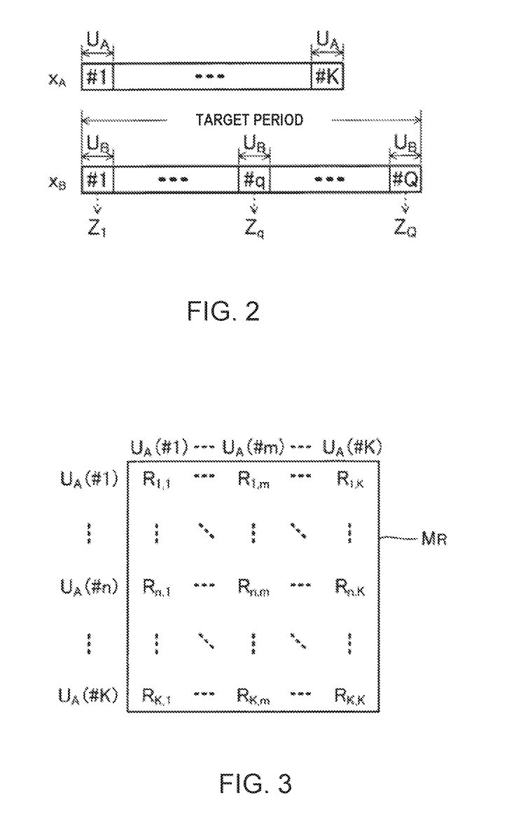

The electronic controller 12 is formed of one or more semiconductor chips that are mounted on a printed circuit board. The term “electronic controller” as used herein refers to hardware that executes software programs. The electronic controller 12 includes a processing circuit such as a CPU (Central Processing Unit) having at least one processor that comprehensively controls each element of the audio processing device 100. As is illustrated in FIG. 2, the electronic controller 12 of the first embodiment generates an audio signal x_{B} (example of a second audio signal) obtained by time axis expanding/compressing the audio signal x_{A} on a time axis. The sound output device 18 of FIG. 1 (for example, a speaker or headphones) outputs sound corresponding to the audio signal x_{B} that is generated by the electronic controller 12. Illustrations of a D/A converter that converts the audio signal x_{B} from digital to analog and of an amplifier that amplifies the audio signal x_{B} have been omitted for the sake of brevity.

The input device 16 is a user operable input device that receives instructions from a user. For example, a plurality of operators or a touch panel can be suitably used as the input device 16. By appropriately operating the input device 16, the user can arbitrarily set the expansion/compression ratio α. The expansion/compression ratio 60 is a time ratio of the audio signal x_{B} relative to the audio signal x_{A}. That is, as illustrated in FIG. 2, the electronic controller 12 generates an audio signal x_{B} over a period having a time length that is α times the audio signal x_{A} (hereinafter referred to as “target period”). Specifically, when the expansion/compression ratio α is less than 1, an audio signal x_{B} obtained by compression of the audio signal x_{A} on a time axis is generated, and when the expansion/compression ratio α exceeds 1, an audio signal x_{B} obtained by expanding the audio signal x_{A} on a time axis is generated.

As illustrated in FIG. 1, the electronic controller 12 of the first embodiment realizes a plurality of functions (a feature extraction unit 22, an index calculation unit 24, an analysis processing unit 26, and a signal generating unit 28) for generating an audio signal x_{B} by time axis expanding/compressing the audio signal x_{A}, by executing a program stored in the storage device 14. Moreover, a configuration in which the functions of the electronic controller 12 are distributed to a plurality of devices or a configuration in which all or part of the functions of the electronic controller 12 are realized by a dedicated electronic circuit may also be employed.

The feature extraction unit 22 extracts a feature quantity F relating to the acoustic characteristics of the audio signal x_{A}. As illustrated in FIG. 2, the feature extraction unit 22 of the first embodiment extracts a feature quantity F of the audio signal x_{A} for each of a plurality (K) of periods U_{A} obtained by dividing the audio signal x_{A} on the time axis. Each period U_{A} (example of a first period) is a section (frame) having a prescribed time length. Successive periods U_{A} can overlap. The type of feature quantity F that is extracted by the feature extraction unit 22 is arbitrary, but it is preferably a type of feature quantity F with which it is possible to appropriately express an auditory characteristic of the sound presented by the audio signal x_{A}. For example, the amplitude spectrum of the audio signal x_{A}, or the temporal change of the amplitude spectrum (for example, temporal differentiation) are suitable as the feature quantity F. It is also possible to extract the pitch, the power, the spectral envelope, etc., from the audio signal x_{A} as the feature quantity F. In addition, for example, if the audio signal x_{A} represents the sound of a percussion instrument being played, then a feature quantity F such as power, attenuation characteristic (attenuation factor from the point of sound generation), or MFCC (Mel-Frequency Cepstrum Coefficients) is suitable.

The index calculation unit 24 calculates similarity indices R_{n, m} of the feature quantities F between each of the K periods U_{A} of the audio signal x_{A}. The index calculation unit 24 of the first embodiment generates a similarity matrix MR such as that illustrated in FIG. 3. A similarity matrix MR is a square matrix of K rows×K columns, having similar indices R_{1,1} to R_{K,K} as elements. With regard to the similarity matrix MR, the similarity index R_{n,m} positioned in the nth row and mth column (n, m=1 to K) is an indicator of similarity between the feature quantity F of the nth period U_{A} and the feature quantity F of the mth period U_{A}, from among the K periods U_{A}. In the first embodiment, the distance between two feature quantities F is exemplified as the similarity index R_{n,m}. A typical example of a distance that can be used as the similarity index R_{n,m} is the Euclidean distance. However, various distance standards, such as the Itakura-Saito distance or I-divergence, can also be used as the similarity index R_{n,m}. As can be understood from the description above, in the first embodiment, the similarity index R_{n,m} takes on smaller numerical values as the two feature quantities F become more similar to each other.

The analysis processing unit 26 makes one of the K periods U_{A} of the audio signal X_{A} correspond to each of a plurality (Q) periods U_{B} within a target period of FIG. 2 over a time length that is a times the audio signal x_{A}. That is, a path search process that analyzes the optimum correspondence between each period U_{A} of the audio signal x_{A} and each period U_{B} of the audio signal x_{B} is executed. Specifically, the analysis processing unit 26 calculates Q indices Z₁ to Z_{Q}, which correspond to different periods U_{B} within the target period. One arbitrary index Z_{q} is set to the number (1 to K) of the period U_{A} that corresponds to the qth (l=1 to Q) period U_{B} of the target period, from among the K periods U_{A} of the audio signal x_{A}. Each period U_{B} (example of a second period) is a section having a prescribed time length. Successive periods U_{B} can overlap.

The signal generating unit 28 generates an audio signal x_{B} over the target period from the result (indices Z₁ to Z_{Q}) of the analysis processing unit 26 making the period U_{A} correspond to each of the Q periods U_{B}. Briefly, the audio signal x_{B} over the target period is generated by arranging the period U_{A} specified by one arbitrary index Z_{q} from among the K periods U_{A} of the audio signal x_{A} over the Q periods U_{B}.

Specifically, the signal generating unit 28 generates the complex spectra X_{B1} to X_{BQ} of the audio signal x_{B} for each period U_{B} from the complex spectra X_{A1} to X_{AK} of each period U_{A} of the audio signal x_{A}, converts each of the plurality of complex spectra X_{B1} to X_{BQ} into the time domain by an inverse Fourier transform and then interconnects them, thereby generating an audio signal x_{B}. The complex spectrum X_{Bq} of the audio signal x_{B} in one arbitrary period U_{B}, for example, can be expressed by the following formula (1).

Formula 1

X_{Bq}=|X_{AZq}|∠(arg X_{Bq-1}+Δϕ_{q}) (1)

X_{B1}=X_{AZ1}

Δϕ_{q}=arg(X_{AZq})−arg(X_{AZq-1})

That is, the complex spectrum X_{Bq} of the qth period U_{B} of the audio signal x_{B} is made up of the amplitude spectrum |X_{AZq}| of the period U_{A} of the audio signal x_{A} specified by the index Z_{q} and the phase spectrum obtained by adding the phase difference Δφ_{q} to the phase angle arg X_{Bq-1} of the immediately preceding (q−1)th period U_{B}. The phase difference Δφ_{q} is the difference between the phase angle arg (X_{AZq}) for the period U_{A} of the audio signal x_{A} specified by the index Z_{q} and the phase angle arg (X_{AZq-1}) of the immediately preceding period U_{A}. That is, the signal generating unit 28 of the first embodiment generates the complex spectrum X_{Bq} of the audio signal x_{B} by using a phase vocoder technique. However, the method for generating an audio signal x_{B} corresponding to the processing result by the analysis processing unit 26 is not limited to the example described above. For example, it is also possible to generate an audio signal x_{B} by using audio processing technique such as PSOLA (Pitch Synchronous Overlap and Add), or the like.

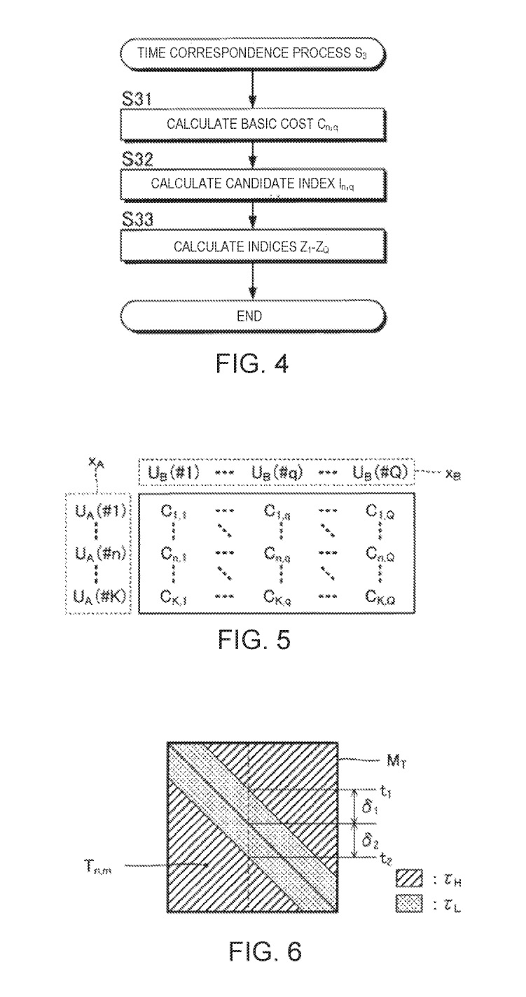

The specific operation of the analysis processing unit 26 will now be described. FIG. 4 is a flowchart of a process for the analysis processing unit 26 to make a period U_{A} correspond to each of Q periods U_{B} (hereinafter referred to as “time correspondence process”) 53.

The analysis processing unit 26 calculates a basic cost C_{n,q} for each period U_{A} Of the audio signal x_{A} for each of the Q periods U_{B} within the target period (S31). The basic cost C_{n,q} is calculated for each combination of each;of the K periods U_{A} and each of the Q periods U_{B}. As illustrated in FIG. 5, a matrix with K rows and Q columns having the basic costs C_{n,q}(C_{1,1} to C_{K,Q}) as elements is generated. One arbitrary basic cost C_{n,q} is the minimum cost when reproducing the nth period U_{A} of the audio signal x_{A} in the qth period U_{B} of the audio signal x_{B}. Specifically, as is expressed by the following recurrence formula (2), the analysis processing unit 26 calculates the minimum value (min) of K allocation costs Ψ_{q-1,n,1} to Ψ_{q-1,n,K}, which correspond to different periods U_{A}, calculated with respect to the immediately preceding ((q−1)th) period U_{B}, as the basic cost C_{n,q}.

$$Formula 2$$

$$\begin{matrix}{C}_{n , q} = {min}_{m} \{ {C}_{m , q - 1} + {R}_{n - 1 , m} + {T}_{n , m} \} \\ = {min}_{m} {Ψ}_{q - 1 , n , m}\end{matrix} \qquad ( 2 )$$

As can be understood from formula (2), the allocation cost Ψ_{q-1,n,m} that is used for calculating the basic cost C_{n,q} that corresponds to the qth period U_{B} and the nth period U_{A} is the sum of the basic cost C_{m,q-1} of the immediately preceding period U_{B}, the similarity index R_{n-1,m}, and the transition cost T_{n,m}. The similarity index R_{n-1,m} is the distance of the feature quantity F between the (n−1)th period U_{A} of the audio signal x_{A} and an arbitrary (mth) period U_{A} of the audio signal x_{A}. Therefore, the allocation cost Ψ_{q-1,n,m} becomes a smaller numerical value and becomes more likely to be selected as the basic cost C_{n,q}, as the feature quantities F become more similar between the (n−1)th period U_{A} and the /nth period U_{A} of the audio signal x_{A}.

The transition cost T_{n,m} is the cost when transitioning from the nth period U_{A} to an arbitrary (mth) period U_{A} of the audio signal x_{A}. Specifically, as shown in FIG. 6, a transition matrix MT of K rows×K columns having transition costs as elements is stored in the storage device 14, and the analysis processing unit 26 specifies the transition cost T_{n,m} that corresponds to the combination of arbitrary periods U_{A} from the transition matrix MT.

If there is a jump in the audio signal x_{B} to a period U_{A} (mth) that is separated from the nth period U_{A} of the audio signal x_{A} on the time axis, then the reproduced audio signal x_{B} creates an unnatural sound. Therefore, the analysis processing unit 26 sets the transition cost T_{n,m} for a transition from the nth period U_{A} to a period U_{A} that is ahead of time t₁, which is earlier than the nth period U_{A} by a threshold δ₁ (n−δ₁>m), to a numerical value τ_{H}. Similarly, the analysis processing unit 26 sets the transition cost T_{n,m} for a transition from the nth period U_{A} to a period U_{A} that is after time t₂, which is later than the nth period U_{A} by a threshold δ₂ (n+δ₂<m), to a numerical value τ_{H}. The numerical value τ_{H} is a sufficiently lame numerical value (for example, to τ_{H}=∞). Therefore, the allocation cost Ψ_{q-1,n,m} that corresponds to a transition from the nth period U_{A} to a period ahead of time t₁, or, the allocation cost Ψ_{q-1,n,m} that corresponds to a transition from the nth period to a period after time t₂, is not selected as the basic cost C_{n,q}. On the other hand, the transition cost T_{n,m} for a transition from the nth period U_{A} to a period between time t₁, which is earlier than the nth period U_{A} by a threshold δ₁ and time t₂, which is later than the nth period U_{A} by a threshold δ₂ (n−δ₁≤m≤n+δ₂), is set to a numerical value τ_{L}. The numerical value τ_{L} is a numerical value that is sufficiently less than the numerical value τ_{H} (for example, zero). That is, a transition within a prescribed range with respect to the nth period U_{A} is permitted. The setting of the transition cost T_{n,m} illustrated above can be expressed by the following formula (3).

$$Formula 3$$

$${T}_{n , m} = \{ \begin{matrix}{τ}_{L} & if n - {δ}_{1} \leq m \leq n + {δ}_{2} \\ {τ}_{H} & if n + {δ}_{2} < m or n - {δ}_{1} > m\end{matrix} \qquad ( 3 )$$

In addition to the calculation of the;basic cost C_{n,q} illustrated above, the analysis processing unit 26 of the first embodiment calculates a candidate index I_{n,q} by using the following recurrence formula (4) (S32).

$$Formula 4$$

$$\begin{matrix}{I}_{n , q} = {arg min}_{m} \{ {C}_{m , q - 1} + {R}_{n - 1 , m} + {T}_{n , m} \} \\ = {arg min}_{m} {Ψ}_{q - 1 , n , m}\end{matrix} \qquad ( 4 )$$

That is, the analysis processing unit 26 calculates a variable in that minimizes the allocation cost Ψ_{q-1,n,m} as a candidate index I_{n,q} of the qth period U_{B}. Specifically, a variable m that corresponds to the minimum value of K allocation costs Ψ_{q-1,n,1} to Ψ_{q-1,n,K}, calculated for the immediately preceding ((q−1)-th) period U_{B} and corresponding to different periods U_{A}, is adopted as the candidate index I_{n,q} of the period U_{B}.

Then, as is expressed by the following formula (5), the analysis processing unit 26 sets an index Z_{Q} at the end (qth) of the target period to the number K of the period U_{A} that is positioned at the end of the audio signal x_{A}, and, by tracking back the candidate index I_{n,q} (backtrack) toward the front of the time axis therefrom, sets an index Z_{q} for each of the Q periods U_{B} within the target period (S33).

$$Formula 5$$

$${Z}_{q} = \{ \begin{matrix}N & q = Q \\ {I}_{Zp + 1 , q + 1} & q < Q\end{matrix} \qquad ( 5 )$$

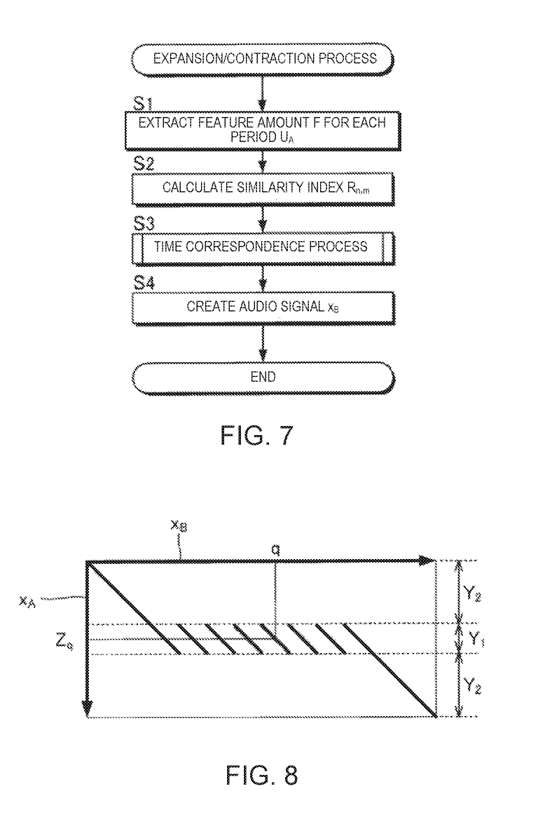

FIG. 7 is a flowchart of a process for the audio processing device 100 of the first embodiment to expand/compress the audio signal x_{A} (hereinafter referred to as “time axis expansion/compression process”). For example, the time axis expansion/compression process of FIG. 7 is started when the user gives the input device 16 an operation to instruct a time axis expansion/compression of the audio signal x_{A}.

When the time axis expansion/compression process is started, the feature extraction unit 22 extracts a feature quantity F for each period U_{A} of the audio signal x_{A} stored in the storage device 14 (S1). The index calculation unit 24 calculates similarity indices R_{n,m} of the feature quantities F extracted by the feature extraction unit 22 between each of the K periods U_{A} of the audio signal x_{A} (S2).

The analysis processing unit 26 makes the period U_{A} correspond to each of the Q periods U_{B} within the target period by using the time correspondence process S3 (S31-S33) described above with reference to FIG. 4. That is, the analysis processing unit 26 sets an index Z_{q} for each of the Q periods U_{B}. The signal generating unit 28 generates an audio signal x_{B} over the target period from the result (indices Z₁ to Z_{Q}) of the time correspondence process S3 (S4).

FIG. 8 is a schematic view of the correspondence relationship between the audio signal x_{A} (vertical axis) and the audio signal x_{B} (horizontal axis). As described above, the analysis processing unit 26 makes one of the K periods U_{A} Of the audio signal x_{A} correspond to each of the Q periods U_{B} within a target period, in accordance with the allocation cost Ψ_{q-1,n,m}. Specifically, the analysis processing unit 26 makes one of the K periods U_{A} correspond to each period U_{B} such that the allocation cost Ψ_{q-1,n,m} is decreased (more preferably, minimized). The allocation cost Ψ_{q-1,n,m} of the first embodiment is calculated according to the similarity index R_{n-1,m} of the feature quantity F between the ((n−1)th) period immediately before the nth period and the mth period U_{A}. Therefore, as is illustrated in FIG. 8, a section Y₁ that includes a steady section of the audio signal x_{A} in which the feature quantity F is steadily maintained on the time axis, and a fluctuation section in which a fluctuation of the feature quantity F is repeated (for example, one cycle of vibrato), is expanded/compressed on the time axis (that is, repeated multiple times), and a transient section Y₂ in which a fluctuation of the feature quantity F does not resemble that of other sections (for example, a section in which the feature quantity F fluctuates unsteadily, such as with a glissando) is excluded as an object of time axis expansion/compression. Thus, for example, compared with a configuration in which both a steady section in which the feature quantity F is steadily maintained and a transient section in which the feature quantity F fluctuates unsteadily are expanded/compressed in the same manner, it is possible to expand/compress the audio signal x_{A} while maintaining auditory naturalness.

In addition, because the allocation cost Ψ_{q-1,n,m} of the first embodiment is calculated according to the transition cost T_{n,m} from the nth period U_{A} to the mth period U_{A}, a transition between two periods U_{A} that widely diverge from each other on the time axis is restricted. From the above point of view as well, it is possible to realize the above-described effect of being able to expand/compress the audio signal x_{A} while maintaining auditory naturalness. In the first embodiment in particular, the transition cost T_{n,m} is set to the numerical value τ_{L} (example of a first value) when the time difference between the nth period U_{A} and the mth period U_{A} is below a threshold value (n−δ₁≤m≤n+δ₂), and the transition cost T_{n,m} is set to the numerical value τ_{H} (example of a second value) when the time difference exceeds the threshold value (n−δ₁>m, n+δ₂<M). That is, the transition between two periods U_{A} of the audio signal x_{A} is constrained within a prescribed range. Therefore, it is to be noted that the above-described effect, that it is possible to expand/compress audio signals while maintaining auditory naturalness, is remarkable.

### Second Embodiment

The second embodiment of the present invention will now be described. In each of the embodiments illustrated below, elements that have the same actions or functions as in the first embodiment have been the same reference symbols as those used to describe the first embodiment, and detailed descriptions thereof have been appropriately omitted.

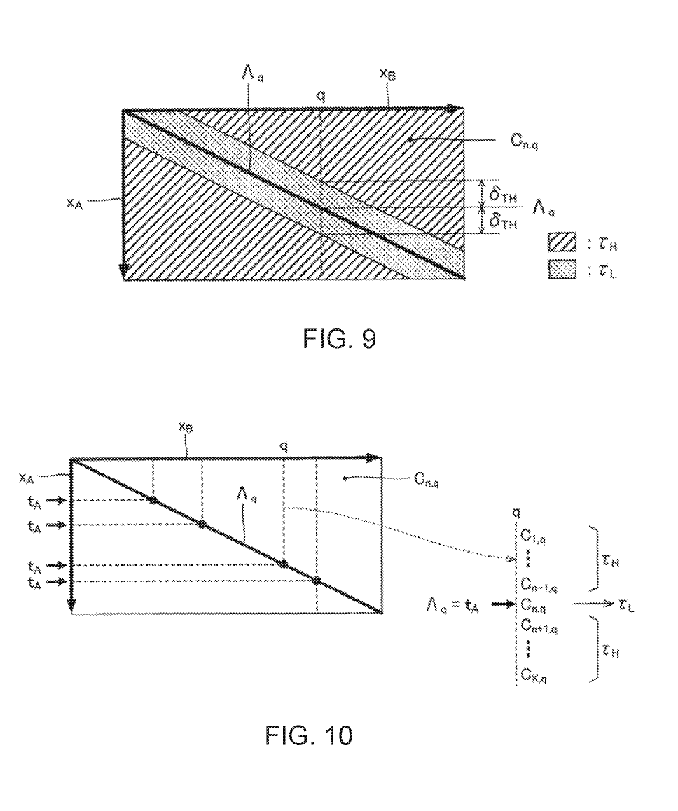

In the second embodiment, as well as in the third embodiment, which is described below, a provisional relationship (hereinafter referred to as “provisional relationship”) is set between each of the periods U_{A} of the audio signal x_{A} and each of the periods U_{B} of the audio signal x_{B}, and an index Z_{q} is set for each of the periods U_{B} within the target period so as to not excessively deviate from the provisional relationship. As illustrated in FIG. 9, the provisional relationship is defined by a provisional index A_{q}, which indicates the relationship between each period U_{A} and each period U_{B}. For example, in the second embodiment, the provisional index A_{q} is defined b the following formula (6), in order to express a provisional relationship in which the first period U_{A} to the Kth period U_{A} of the audio signal x_{A} uniformly correspond to the time series of Q periods U_{B}.

$$Formula 6$$

$${Λ}_{q} = \frac{q}{α} \qquad ( 6 )$$

As can be understood from formula (6), under the provisional relationship, the Kth period U_{A} of the audio signal x_{A} corresponds to the qth period U_{B} (q=Q=αK)(A_{Q}=K). As can be understood from formula (6), it can also be said that the provisional relationship of the second embodiment is a correspondence relationship between each period U_{A} and each period U_{B}, when the audio signal x_{A} is uniformly expanded/compressed over all the sections to generate the audio signal x_{B}.

In the second embodiment, the basic cost C_{n,q} is set such that the relationship between each period U_{A} and each period U_{B} specified by the index Z_{q} does not deviate widely from the provisional relationship of formula (6). Specifically, the analysis processing unit 26 sets the basic cost C_{n,q} by means of the following formula (7).

Formula 7

C_{n,q}=τ_{H} if |A_{q}−n|>δ_{TH} (7)

As can be understood from formula (7), of K basic costs C_{t,q} to C_{K,q} that are calculated for the qth period U_{B}, a basic cost C_{n,q} that is outside of a prescribed range (hereinafter referred to as “allowable range”) that corresponds to the period U_{B} on the basis of the provisional relationship of formula (6), is set to the numerical value τ_{H}. As is illustrated in FIG. 9, the allowable range is a range with a prescribed width (2×δTH) centered around the period U_{A} indicated by the provisional index A_{q}. The numerical value τ_{H} of formula (7) is set to a sufficiently large numerical value (for example, τ_{H}=∞). Thus, the relationship between each period U_{A} and each period U_{B} is limited to within the allowable range with respect to the provisional relationship.

As can be understood from the description above, in the second embodiment, the basic cost C_{n,q} is set such that a period U_{A} within an allowable range defined by the provisional relationship of formula (6) corresponds to the qth period U_{B}. Thus, it is possible to generate the audio signal x_{B} within a range that does not deviate widely from the provisional relationship between each period U_{A} and each period U_{B}.

### Third Embodiment

FIG. 10 is an explanatory view of the basic cost C_{n,q} in the third embodiment. If the ratio of the interval between the points in time when various sounds start in the audio signal x_{A} (hereinafter referred to as “sound generation points”) changes without being maintained in the audio signal x_{B}, the reproduced audio signal x_{B} will sound unnatural, wherein the rhythm of generated sound fluctuates irregularly. Therefore, in the third embodiment, as illustrated in FIG. 10, the basic cost C_{n,q} is set such that a period U_{A} of the audio signal x_{A} corresponding to a sound generation point t_{A}, and a period U_{B} corresponding to said sound generation point t_{A} under a provisional relationship, correspond to each other. Any known technique can be employed for detecting the sound generation point t_{A} of the audio signal x_{A}.

Specifically, the analysis processing unit 26 sets the basic cost C_{n,q} as in formula (8) below with respect to a period U_{B} corresponding to a sound generation point t_{A} of the audio signal X_{A} under the provisional relationship (that is, the period U_{B} in which A_{q}=t_{A}).

$$Formula 8$$

$${C}_{n , q} = \{ \begin{matrix}{τ}_{L} & n = {Λ}_{q} \\ {τ}_{H} & n \neq {Λ}_{q}\end{matrix} \qquad ( 8 )$$

As can be understood from formula (8) and formula (10), of K basic costs C_{1,q} to C_{K,q} that arc calculated for the qth period U_{B} corresponding to the sound generation point t_{A} under the provisional relationship, a basic cost C_{n,q} of one period U_{A} in which the sound generation point t_{A} exists (n=A_{q}) is set to the numerical value τ_{L}. On the other hand, the basic cost C_{n,q} of a period U_{A} in which the sound generation point t_{A} does not exist (n ≠ A_{q}) is set to a numerical value τ_{H}, which sufficiently exceeds the numerical value τ_{L}. The numerical value τ_{L} is, for example, set to zero (τ_{L}=0), and the numerical value τ_{H} is, for example, set to infinity (τ_{H}=∞).

According to the configuration above, with respect to a period U_{B} corresponding to the sound generation point t_{A} wider the provisional relationship, only the number n of the period U_{A}, which corresponds to said sound generation point t_{A} from among K periods U_{A}, is employed as the index Z_{q}. Therefore, the time ratio between each sound generation point t_{A} in the sound generation point t_{A} is also equally maintained in the audio signal x_{B}. That is, according to the second embodiment, there is the benefit that it is possible to generate an audibly natural audio signal x_{B}, in which the rhythm of the generated sound remains equal to that of audio signal x_{A}. It is also possible to apply the configuration of the second embodiment to the third embodiment.

### Modifications

Each of the embodiments exemplified above may be variously modified. Specific modified embodiments are illustrated below. Two or more embodiments arbitrarily selected from the following examples can be appropriately combined as long as they are not mutually contradictory.

(1) In each of the above-described embodiments, the analysis processing unit 26 sets the transition cost T_{n,m} with reference to the transition matrix MT illustrated in FIG. 6; however, it is also possible to store a vector that corresponds to one column of the transition matrix MT (hereinafter referred to as “transition vector”) in the storage device 14. The analysis processing unit 26 specifies the transition cost T_{n,m} corresponding to the combination of two periods U_{A} of the transition target front the transition vector. Thus, since it is not necessary to store a transition matrix MT having K rows×K columns, in accordance with the configuration described above, the storage capacity required for the storage device 14 can be reduced.

(2) In each of the above-described embodiments, all of the sections of the audio signal x_{A} are expanded/compressed with a common expansion/compression ratio α; however, it is also possible to change the expansion/compression ratio α in real-time at an arbitrary point in time of the audio signal x_{B}. For example, a configuration is assumed in which the target period is divided into a plurality of unit sections on a time axis, and the time axis expansion/compression process of FIG. 7 is sequentially executed for each unit section. For example, the expansion/compression ratio α is updated for each unit section in accordance with an operation from the input device 16. It is also possible to restrict the period U_{B} at the end of one arbitrary unit section and the period U_{B} at the beginning of the immediately following unit section to a combination of corresponding periods U_{A} therebefore and thereafter of the audio signal x_{A}.

(3) In each of the above-described embodiments, a linear relationship is exemplified (formula (6)) as the provisional relationship between each period U_{A} of the audio signal x_{A} and each period U_{B} of the audio signal x_{B}; however, the provisional relationship is not limited to the example described above. For example, it is also possible to employ a curvilinear relationship (for example, A_{q}=β×q²) as the provisional relationship between each period U_{A} and each period U_{B} (where β is a prescribed positive number).

(4) It is also possible to realize the audio processing device 100 with a server device that communicates with terminal devices (for example, mobile phones and smartphones) via a communication network such as a mobile communication network or the Internet. Specifically, the audio processing device 100 generates an audio signal x_{B} by means of the time axis expansion/compression process illustrated in FIG. 7 that is applied to an audio signal x_{A} received from a terminal device and transmits the audio signal x_{B} after time axis expansion/compression to the terminal device.

(5) The audio processing device 100 illustrated in each of the above-described embodiments is realized cooperation between the electronic controller 12 and a program, as is illustrated in each of the above-described embodiments. A program according to a preferred aspect of the present invention causes a computer to function as a feature extraction unit 22 for extracting a feature quantity F of an audio signal x_{A} for each of a plurality of periods U_{A}; as an index calculation unit 24 for calculating a index R_{n,m} of the feature quantity F between each of the periods U_{A}; as an analysis processing unit 26 for making one of the plurality of periods U_{A} correspond to each of a plurality of periods U_{B} within a target period such that an allocation cost Ψ_{q-1,n,m} corresponding to the similarity index R_{n,m} between each period U_{A} and a transition cost T_{n,m} for transitioning between each period U_{A} is minimized; and as a signal generating unit 28 for generating an audio signal x_{B} over the target period from the result obtained when the analysis processing unit 26 causes the period U_{A} to correspond to each of the plurality of periods U_{B}.

The program exemplified above can be stored on a computer-readable storage medium and installed in a computer. The storage medium is, for example, a non-transitory (non-transitory) storage medium, a good example of which is an optical storage medium, such as a CD-ROM (optical disc), but may include well-known arbitrary storage medium formats, such as semiconductor storage media and magnetic storage media. Non-transitory storage media include any storage medium that excludes transitory propagating signals and does not exclude volatile storage media. Furthermore, it is also possible to deliver the program to a computer in the form of distribution via a communication network.

(6) For example, the following configurations may be understood from the embodiments exemplified above.

### Aspect 1

An audio processing method according to a preferred aspect (Aspect 1) of the present invention comprises extracting a feature quantity of a first audio signal for each of a plurality of periods; and generating a second audio signal by time axis expanding/compressing either a section of the first audio signal in which the feature quantity is steadily maintained for a period time, or a section of the first audio signal in which a fluctuation of the feature quantity is repeated and excluding from the time axis expanding/compressing a section in which a fluctuation of the feature quantity is not similar to that of other sections. Thus, for example, compared with a configuration in which the first audio signal is uniformly expanded/compressed over all the sections including both a steady section in which the feature quantity is steadily maintained and a transient section in which the feature quantity fluctuates unsteadily, it is possible to expand compress the audio signal while maintaining auditory naturalness.

### Aspect 2

An audio processing method according to a preferred aspect (Aspect 2) of the present invention comprises extracting a feature quantity of a first audio signal for each of a plurality of first periods; calculating a similarity index of the feature quantity between each of the plurality of first periods; executing a time correspondence process for making one of the plurality of first periods correspond to a plurality of second periods within a target period after expansion/compression of the first audio signal in accordance with the similarity index and a transition cost for transitioning between each of the plurality of first periods; and generating a second audio signal over the target period from a result obtained making the plurality of first periods correspond to the plurality of second periods. In the aspect described above, a first period is made to correspond to each second period within the target period such that the allocation cost corresponding to the similarity index between each first period is minimized. That is, a section of the first audio signal in which the feature quantity is steadily maintained on the time axis and or a section in which a fluctuation of the feature quantity is repeated (for example, one cycle of vibrato) is expanded/compressed on the time axis, and sections in which a fluctuation of the feature quantity does not resemble that of other sections (for example, a transient section in which the feature quantity fluctuates unsteadily, such as a glissando) are excluded as an object of expansion/compression. Thus, for example, compared to a configuration in which the first audio signal is uniformly expanded/compressed over all the sections including both a steady section in which the feature quantity is steadily maintained and a transient section in which the feature quantity fluctuates unsteadily, it is possible to expand/compress the audio signal while maintaining auditory naturalness. In addition, a first period is made to correspond to each second period within the target period, in in correspondence with the transition cost for transitioning between each of the first periods. Therefore, transitions between first periods that are widely divergent on the time axis is restricted. From the above point of view as well, it is possible to realize the above-described effect of being able to expand/compress the audio signal while maintaining auditory naturalness.

### Aspect 3

In a preferred example (Aspect 3) of Aspect 2, in the time correspondence process, one of the plurality of first periods is made to correspond to each of the plurality of second periods within the target period after expansion/compression of the first audio signal, such that an allocation cost, corresponding to the similarity index and to the transition cost for transitioning between each of the plurality of first periods is reduced. In the aspect described above, a first period is made to correspond to each second period within the target period such that the allocation cost is reduced. Therefore, transitions between first periods that are widely divergent on the time axis is restricted.

### Aspect 4

In a preferred example (Aspect 4) of Aspect 3, in the time correspondence process, one of the plurality of first periods is made to correspond to each of the plurality of second periods within the target period after expansion/compression of the first audio signal, such that the allocation cost is minimized. In the aspect described above, in the aspect described above, a first period is made to correspond to each second period within the target period such that the allocation cost is minimized. Therefore, the effect that transitions between first periods that are excessively divergent on the time axis is restricted is remarkable.

### Aspect 5

In a preferred example (Aspect 5) of any one of Aspects 2 to 4, in the time correspondence process, the transition cost between two first periods from among the plurality of first periods is set to a first value when a time difference between the two first periods is below a threshold value and is set to a second value that is greater the first value when the time difference exceeds the threshold value. In the aspect described above, because the transition cost is set to a first value when the time difference between two first periods is below a threshold value, and the transition cost is set to a second Value that is greater the first value when the time difference exceeds the threshold value, it is possible to constrain the transition between two first periods to within a prescribed range. Therefore, it is to be noted that the above-described effect, that it is possible to expand/compress audio signals while maintaining auditory naturalness, is remarkable.

### Aspect 6

It a preferred example (Aspect 6) of any one of Aspects 2 to 5, in the time correspondence process, a minimum value of an allocation cost immediately preceding one of the plurality of second period is sequentially calculated as a basic cost for each of the plurality of second periods, and one of the plurality of first periods is made to correspond to each of the plurality of second periods so as to minimize the allocation cost in accordance with the basic cost of the immediately preceding one of the plurality of second periods, the similarity index, and the transition cost.

### Aspect 7

In a preferred example (Aspect 7) of Aspect 6, in the time correspondence process, the basic cost is set for each of the plurality second periods such that one of the plurality of first period within a prescribed range corresponds to one of the plurality of second periods, based on a provisional relationship between each of the plurality of first periods and each of the plurality of second periods. In the aspect described above, the basic cost is set such that a first period corresponds to each of a plurality second periods within a prescribed range that corresponds to the second period, on the basis of a provisional relationship between each first period and each second period. Thus, it is possible to generate a second audio signal within a range that does not deviate widely from a provisional relationship between each first period and each second period.

### Aspect 8

In a preferred example (Aspect 8) of Aspect 6 or 7, in the time correspondence process, the basic cost is set such that one of the plurality of first periods corresponding to a sound generation point of the first audio signal and one of the plurality of second period corresponding to the sound generation point based on a provisional relationship between each of the plurality of first periods and each of the plurality of second periods correspond to each other. In the aspect described above, the basic cost is set such that a first period corresponding to a sound generation point of a first audio signal and a second period corresponding to the sound generation point on the basis of a provisional relationship between each first period and each second period correspond to each other. That is, a second audio signal that reflects the time ratio between each sound generation point in the first audio signal (for example, a second audio signal in which the time ratio between each sound generation point is kept the same as in the first audio signal) is generated. Therefore, there is the benefit that it is possible to generate an audibly natural second audio signal in which the rhythm of the sound remains equal to that of the first audio signal.

### Aspect 9

In a preferred example (aspect 9) of aspect 7 or 8, the provisional relationship is a linear relationship. In the aspect described above, there is the benefit that the provisional relationship is simplified.

### Aspect 10

In a preferred example (aspect 10) of aspect 7 or 8, the provisional relationship is a curvilinear relationship. In the aspect described above, it is possible to make the first period and the second period correspond to each other by means of various types of relationships that are not limited to a linear relationship.

### Aspect 11

In a preferred example (Aspect 11) of any one of Aspects 2 to 10, in the time correspondence process the transition cost to be applied to the time correspondence process is specified from a transition matrix whose elements are transition costs that correspond to combinations of the plurality of first periods.

### Aspect 12

In a preferred example (Aspect 12) of any one of Aspects 2 to 10, in the time correspondence process, a transition cost to be applied to the time correspondence process is specified from a transition vector that corresponds to one column of a transition matrix whose elements are transition costs that correspond to combinations of each of the plurality of first periods. In the aspect described above, because the transition cost is specified from a transition vector that corresponds to one column of a transition matrix, it is not necessary to store an entire transition matrix. Therefore, there is he benefit that the storage capacity required for the time correspondence process can he reduced.

### Aspect 13

An audio processing device according to a preferred aspect (Aspect 13) of the present invention comprises an electronic controller having a feature extraction unit and a signal generating unit. The feature extraction unit is configured to extract a feature quantity of a first audio signal for each of a plurality of periods. The signal generating unit is configured to generate a second audio signal by time axis expanding/compressing on a time axis either a section of the first audio signal in which the feature quantity is steadily maintained for a period time, or a section of the first audio signal in which a fluctuation of the feature quantity is repeated and excluding from the time axis expanding/compressing a section of the first audio signal in which a fluctuation of the feature quantity is not similar to that of other sections of the first audio signal. According to the configuration described above, for example, compared to a configuration in which the first audio signal is uniformly expanded/compressed over all the sections including both a steady section in which the feature quantity is steadily maintained and a transient section in which the feature quantity fluctuates unsteadily, it is possible to expand/compress the audio signal while maintaining auditory naturalness.

### Aspect 14

An audio processing device according to a preferred aspect (Aspect 14) of the present invention comprises an electronic controller having a feature extraction unit, an index calculation unit, an analysis processing unit and a signal generating unit. The feature extraction unit is configured to extract a feature quantity of a first audio signal for each of a plurality of first periods; an index calculation unit is configured to calculate a similarity index of the feature quantity between each of the plurality of first periods. The analysis processing unit is configured to make the plurality of first periods correspond to a plurality of second periods within a target period after expansion/compression of the first audio signal in accordance with the similarity index and a transition cost for transitioning between each of the plurality of first periods. The signal generating unit is configured to generate a second audio signal over the target period from a result obtained upon the analysis processing unit making the plurality of first periods correspond to the plurality of second periods. In the aspect described above, a first period is made to correspond to each second period within the target period such that the allocation cost corresponding to the similarity index between each first period is minimized. That is, a section of the first audio signal in which the feature quantity is steadily maintained on the time axis and a section in which the fluctuation of the feature quantity is repeated are expanded/compressed on the time axis, and sections in which a fluctuation of the feature quantity does not resemble that of other sections are excluded from the subject of expansion/compression. Thus, for example, compared to a configuration in which the first audio signal is evenly expanded/compressed over all the sections including both a steady section in which a feature quantity is steadily maintained and a transient section in which the feature quantity fluctuates unsteadily, it is possible to expand/compress the audio signal while maintaining auditory naturalness. In addition, a first period is made to correspond to each second period within the target period in relation to the transition cost for transitioning between each of the first periods. Therefore, transitions between first periods that are excessively divergent on the time axis are restricted. Consequently, it is possible to realize the above-described effect of being able to expand/compress the audio signal while maintaining auditory naturalness.

What is claimed is:

1. An audio processing method comprising:
extracting a feature quantity of a first audio signal for each of a plurality of periods; and
generating a second audio signal by time axis expanding/compressing on a time axis either a section of the first audio signal in which the feature quantity is steadily maintained for a period time, or a section of the first audio signal in which a fluctuation of the feature quantity is repeated and excluding from the time axis expanding/compressing a section of the first audio signal in which a fluctuation of the feature quantity is not similar to that of other sections of the first audio signal.

2. An audio processing method comprising:
extracting a feature quantity of a first audio signal for each of a plurality at first periods;
calculating a similarity index of the feature quantity between each of the plurality of first periods;
executing a time correspondence process for making the plurality of first periods correspond to a plurality of second periods within a target period after expansion/compression of the fist audio signal, in accordance with the similarity index and a transition cost for transitioning between each of the plurality of first periods; and
generating a second audio signal over the target period from a result obtained by making the plurality of first periods correspond to the plurality of second periods.

3. The audio processing method recited in claim 2, wherein
in the time correspondence process, one of the plurality of first periods is made to correspond to each of the plurality of second periods Within the target period after expansion/compression of the first audio signal, such that an allocation cost corresponding to the similarity index and to the transition cost for transitioning between each of the plurality of first periods is reduced.

4. The audio processing method recited in claim 3, wherein
in the time correspondence process, one of the plurality of first periods is made to correspond to each of the plurality of second periods within the target period after expansion/compression of the first audio signal, such that the allocation cost is minimized.

5. The audio processing method recited in claim 2, wherein
in the time correspondence process, the transition cost between two first periods from among the plurality of first periods is set to a first value when a time difference between the two first periods is below a threshold value and is set to a second value that is greater the first value when the time difference exceeds the threshold value.

6. The audio processing method recited in claim 2, wherein
in the time correspondence process, a minimum value of an allocation cost immediately preceding one of the plurality of second periods is sequentially calculated as a basic cost for each of the plurality of second periods, and one of the plurality of first periods is made to correspond to each of the plurality of second periods so as to minimize the allocation cost in accordance with the basic cost of the immediately preceding one of the plurality of second periods, the similarity index, and the transition cost.

7. The audio processing method recited in claim 6, wherein
in the time correspondence process, the basic cost is set for each of the plurality second periods such that one of the plurality of first periods within a prescribed range corresponds to one of the plurality of second periods based on a provisional relationship between each of the plurality of first periods and each of the plurality of second periods.

8. The audio processing method recited in claim 7, wherein
the provisional relationship is a linear relationship.

9. The audio processing method recited in claim 7, wherein
the provisional relationship is a curvilinear relationship.

10. The audio processing method recited in claim 6, wherein
in the time correspondence process, the basic cost is set such that one of the plurality of first periods corresponding to a sound generation point of the first audio signal, and one of the plurality of second periods corresponding to the sound generation point based on a provisional relationship between each of the plurality of first periods and each of the plurality of second periods, correspond to each other.

11. The audio processing method recited in claim 10, wherein
the provisional relationship is a linear relationship.

12. The audio processing method recited in claim 10, wherein
the provisional relationship is a curvilinear relationship.

13. The audio processing method recited in claim 2, wherein
in the time correspondence process, the transition cost to be applied to the time correspondence process is specified from a transition Matrix whose elements are transition costs that correspond to combinations of the plurality of first periods.

14. The audio processing method recited in claim 2, wherein
in the time correspondence process, the transition cost to be applied to the time correspondence process is specified from a transition vector that corresponds to one column of a transition matrix whose elements are transition costs that correspond to combinations of each of the plurality of first periods.

15. An audio processing device comprising:
an electronic controller having a feature extraction unit and a signal generating unit, the feature extraction unit being configured to extract a feature quantity of a first audio signal for each of a plurality of periods; and
the signal generating unit being configured to generate a second audio signal by time axis expanding/compressing on a time axis either a section of the first audio signal in which the feature quantity is steadily maintained for a period time, or a section of the first audio signal in which a fluctuation of the feature quantity is repeated and excluding from the time axis expanding compressing a section of the first audio signal in which a fluctuation of the feature quantity is not similar to that of other sections of the first audio signal.

16. An audio processing device comprising:
an electronic controller having a feature extraction unit, an index calculation unit, an analysis processing unit and a signal generating unit,
the feature extraction unit being configured to extracting a feature quantity of a first audio signal for each of a plurality of first periods;
the index calculation unit being configured to calculate a similarity index of the feature quantity between each of the plurality of first periods;
the analysis processing unit being configured to make the plurality of first periods correspond to a plurality of second periods within a target period after expansion/compression of the first audio signal in accordance with the similarity index and a transition cost for transitioning between each of the plurality of first periods; and
the signal generating unit being configured to generate a second audio signal over the target period from a result obtained upon the analysis processing unit making the plurality of first periods to correspond to the plurality of second periods.
